(19) United States
(12) Patent Application Publication
(10) Pub. No.: US 2025/0131165 A1
(43) Pub. Date: Apr. 24, 2025

(54) SYSTEM AND METHOD FOR DESIGN EXPLORATION USING DYNAMIC ENVIRONMENT AND PHYSICS SIMULATIONS

(71) Applicant: Siemens Corporation, Washington, DC (US)

(72) Inventors: Lucia Mirabella, Plainsboro, NJ (US); Edward Slavin III, Robbinsville, NJ (US); Tsz Ling Elaine Tang, Plainsboro, NJ (US)

(73) Assignee: Siemens Corporation, Washington, DC (US)

(21) Appl. No.: 18/682,675

(22) PCT Filed: Aug. 31, 2021
(86) PCT No.: PCT/US2021/048407

§ 371 Date: Feb. 9, 2024

(51) Int. Cl. G06F 30/27; G06F 30/12; G06F 111/20

(52) U.S. Cl. CPC G06F 30/27; G06F 30/12; G06F 2111/20

(57) ABSTRACT

A system and method are disclosed for preliminary design validation of a target design entity. A realistic dynamic environment module simulates dynamic conditions of an environment related to the target design entity. An interactive platform module drives a user interface for interactive placement and modification of environmental scenario assets obtained from an asset library, interactive placement of the target design entity within the virtual environment, and intuitive modification of shape and material properties of the target design entity. Assets are updated for use by the realistic dynamic environment module and automatically converted to boundary conditions. Physics simulator module executes physics simulations that augment environmental scenario assets by incorporating expected physics behavior, the effect of such behavior on other entities, and the impact of other physics aspects generated by other entities onto the target design entity.

### TECHNICAL FIELD

This application relates to computer aided design. More particularly, this application relates to simulation of a realistic dynamic environment with physics solvers for preliminary design exploration of a target design entity.

### BACKGROUND

In the field of engineering, a common task is analyzing 3D design problems, in which a target design object must perform a task while withstanding environmental forces, such as designing a truss for a bridge that must support dynamic design loads of bridge traffic along with shear force of wind. The design space can be quite large with many possibilities to be narrowed down to a space that the engineer is familiar with based on experience or other factors. Time is not unlimited, however, and the design process is often burdened by delays of many factors, such as design layer translations across multiple designers, and the time and computational resources required to perform high fidelity physics simulation to estimate performance of a given design iteration and perform design optimization. Consequently, design variations and alternative design space areas often cannot be fully explored.

A typical sequence in a conventional design process involves the following steps. Using computer aided design and engineering tools and often in isolation of other components, a product design that is expected to perform well is generated based on prior experience or design intuition. Then the initial design is refined following geometric considerations. After this, the design is prototyped and tested under representative conditions (e.g., fatigue test on a representative number of load cycles, or deformation evaluated on car components under the maximum velocity condition, etc.).

In modern systems, computer aided engineering tools, such as 3D simulation tools, are often utilized to compute a virtual evaluation of the performance under similar representative conditions, ahead of the prototyping phase. Performing simulations with accurate tools is typically very computationally expensive and require a considerable amount of time, especially when the governing physics is complex. In addition, simulations require specialized expertise and time to be prepared and set up, including generating appropriate initial, boundary and loading conditions from the knowledge of the physics and the context surrounding the portion of the domain to simulate.

In addition, such process is often done in a batch process and has limited interactivity for user to intervene and refine the requirements and constraints on the fly. Only at this point when ideal performance is met, the design would be manufactured and tested under the real conditions in the field (e.g., road testing a car with the designed component installed). Additional design adjustments might be necessary at this point and the best design for the actual conditions might not ever be realized due to the complexity and the length of such process. For example, the test prototype may have gone to manufacturing based on a design iteration that was “good enough” to meet minimum design criteria, having consumed the allotted time limit and perhaps missing the opportunity for further optimized refinement. Often, this design is done in long iteration cycles because changes to one component affect another in the system, but these changes aren't propagated to the second component immediately, resulting in long design cycle times and large non-conformance costs.

To accelerate the design process, various approaches can be applied including the following. A multi-level simulation can be applied, starting with coarse detail level for faster simulation in an initial screening phase, followed by fine level detail for successful candidates. Faster simulation can also be achieved by reducing model fidelity, such as by considering rigid body dynamics only. However, these solutions fail to address the following aspects. The design process lacks an interactive aspect that can provide answers while using current engineering tools. For instance, new environment updates and new boundary conditions require time consuming design reevaluations. Existing tools are also limited by the need for domain expertise in the user for both design and simulation. Virtual evaluations reduce the complexity/accuracy of environmental factors for design evaluation in the interest of simplifying the analysis to keep the scale of the computing model to a manageable level, which sacrifices a realistic environmental simulation at the risk of a manufactured component failing test performance under real conditions. Another difficulty is latency in transferring information from one design process to another, as outputs of one design process (e.g., design of one component in an assembly) often become boundary conditions for another (sometimes with processing needed in between), requiring a manual (often error-prone) data transfer. Lastly, while generative design techniques do allow exploration of design space in a more efficient manner, they are typically interpolative techniques, meaning the candidate answers are largely skewed into the space of what has been previously seen.

### SUMMARY

In an aspect, a system is provided for design exploration of a target design entity. The system includes a realistic dynamic environment module configured to simulate dynamic conditions of an environment related to the target design entity. The system further includes an interactive platform module configured to drive a user interface for (1) interactive placement and modification of environmental scenario assets obtained from an asset library, (2) interactive placement of the target design entity within the virtual environment, and (3) intuitive modification of shape and material properties of the target design entity. The system further includes a context asset module configured to dynamically update assets for use by the realistic dynamic environment module and a context conversion module configured to convert context assets to boundary/initial/loading conditions. The system further includes a physics simulator module configured to execute physics simulations that augment environmental scenario assets by incorporating expected physics behavior, the effect of such behavior on other entities, and the impact of other physics aspects generated by other entities onto the target design entity. Optionally, the system can comprise and design suggestion or optimization module, that utilizes the result of the simulated physics behavior to suggest design options that might meet user requirements.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of a proposed framework of layered modules for design generation in accordance with embodiments of the disclosure.

FIG. 2 shows an example of a computing environment within which embodiments of the disclosure may be implemented.

### DETAILED DESCRIPTION

System and method provide an interactive framework that guides a computer aided design user into the creation or modification of a scenario which accurately represents the environment and physical behaviors in which the target product to design is expected to exist in, once created. An objective is to improve design exploration by allowing engineering evaluation of design performance at the beginning of the design process rather than at the end of a full design simulation. This “earlier than later” approach avoids time expended (e.g., hours or days of computer processing for a single simulation) on time expensive full simulations that may disappointingly generate design failures. A proposed multi-layered framework explores concepts to see if a design candidate passes preliminary analysis before being passed on to the next phase of a more complete design validation. In the aspect of assisting users across a full range of expertise-level, the proposed framework includes features that provide a game-like experience. As the design progresses, simulation processes produce results in near real time, and with faster turnaround with each exploration. While simulations are coarser at first, the results are “good enough” for the designer to confirm if the setup is satisfactory or needs further adjustments. To assist novice users or those lacking expertise in physics, the proposed framework brings the design component into the context of a system and environment for deployment and uses this context as a basis for automating the setup of whatever parameters are required for the simulation. Inputs may include context of where design component will operate, including entities that might contribute to generate the operating conditions of the object undergoing the design process. A simplified interface, on top of managing the creation of the simulation, translates the context into a physics simulation, presents the results in near real time (or at least very rapidly), and allows interaction by the user while simulation is running to explore the design modeling. For example, introducing a heated element in a specific position will implicitly generate a temperature field used as loading surface/volume condition for the object undergoing the design process. In contrast, conventional design simulators that require hours or days to resolve the solution prevent any sense of a user interactive experience.

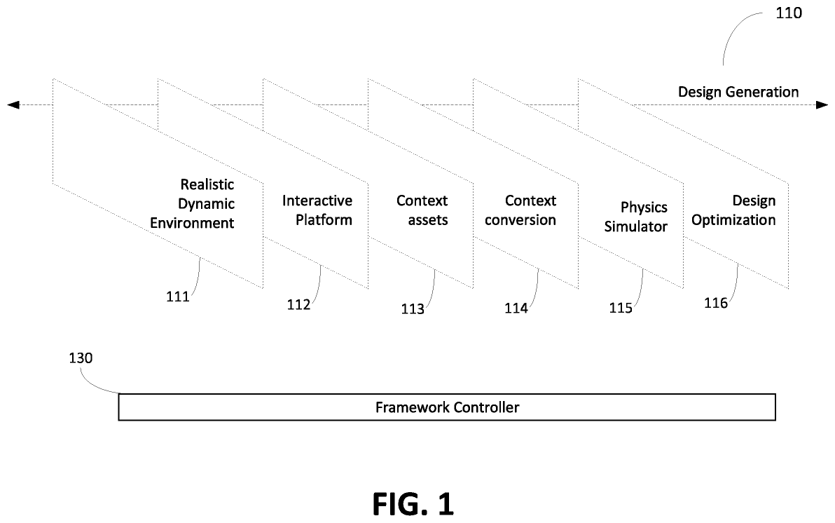

FIG. 1 shows an example of a proposed framework of layered modules for design generation in accordance with embodiments of the disclosure. Framework 100 includes multiple layers of algorithmic modules for concurrent performance of dynamic environment simulation and near real time physics modeling while extracting conditions, context assets, material property, and shape property for the target design. Design generation 110 progresses across the multiple layers in near real time. In an embodiment, middleware (e.g., a game engine) is deployed as a framework layer for realistic environmental simulation (module 111) suitable to provide a game-like user experience of near real time simulation response to user inputs. The middleware for environmental simulation is conducive to setting up virtualized environments and can easily represent environmental assets, background assets, and geometry that are moving and dynamic. Moreover, the middleware is designed to execute basic physics computations relating to physical collisions and other useful manipulations of objects in near real time. However, this middleware layer alone is insufficient to incorporate complex physics analyses related to solving engineering problems, such as fluid dynamics, deformable object simulation, temperature effects, etc. To achieve this, framework 100 includes a module of simulation solvers as a plug-in to the middleware platform, each solver applying different methods with different characteristics in terms of runtime and fidelity. With this plug-in feature, a provider can add more solvers with periodic software updates as the system is used over time. Additionally, the framework 100 allows a user to add customized solvers as needed.

Framework 100 begins the design process by bringing in the environment, which includes the target object and surrounding objects, supporting assets and translating parameters. Next, the user interaction permits changes to the model design and the simulation responds in near real time, with a visualization of the response results. As an implementation example involving an automobile design project, a current target design element relates to the rear body of the automobile, where different air spoilers are to be added to the rear body. In response to a user adding a spoiler design element onto the rear body using a CAD-based user interface, simulations are instantaneously performed that yield drag coefficient results in near real time as feedback for whether each design alteration related to a particular air spoiler is beneficial or detrimental according to design objectives.

Realistic dynamic environment module 111 simulates dynamic environmental conditions related to a target design. In an embodiment, a game engine is used to implement the realistic dynamic environment module 111. Algorithms of this module dynamically switch between simulation fidelities as needed in different parts of the environment and focus on different entities (e.g., akin to geometric level of detail (LOD) management). Multiple virtual environments can be constructed in response to basic user inputs, each being saved as different scenarios to provide a set of simulations that can cover various environmental possibilities for the target design, including the effects on performance over seasonal variations (e.g., exposure to temperature variations and extremes corresponding to the change of seasons) as well as various regional climates in which the target design product could be deployed. In an embodiment, the module 111 includes sample environments from which the user selects and loads. The user may create a custom environment by modifying assets to be combined in a meaningful way by module 111. Once the environment is defined, the simulations can be played out. An advantage provided by implementing this module is to allow the user to focus more on the environment for the target design involving higher level inputs that demand less domain and physics expertise. The remaining layers of modules provide the technical support for automatically handling the higher complexity details for design generation 110. Realistic dynamic environment module 111 collects results of simulations and optimizations performed by modules 115, 116, which can be integrated for a display to a user interface.

Interactive platform module 112 is configured to drive a user interface that provides visualization of a virtual environment to the user allowing interactive placement and modification of environmental context assets obtained from a pre-built asset library. Module 112 further allows for the interactive placement of the target design entity within the virtual environment and is configured to execute modification of the target design entity to edit its shape or material properties. Module 112 drives the user interface to enable the user to enter adjustment inputs (e.g., via virtual control knobs) that tune one or more design parameters or local features of the geometry that will be used by the solvers of physics simulator module 115. In response to adjustment inputs, physics solvers (module 115) apply the appropriate algorithm and conditions (module 114) for the given environmental context assets (module 113). This interactive platform module 112 feature distills simulation complexity to something manageable (e.g., parameter tuning) while retaining the inherent complexity via system management of context. A user interface displays results of the current product design analyses performed by the physics solvers in near real time.

Context assets module 113 is configured to dynamically update assets in the environmental scenario based on design of components in the same context. For example, components having aspects that are dependent on the target component design may require updates (e.g., a target design object being a frame on which other components are to be attached will require updates to dimensions of attached components to maintain assembly specifications in response to altering the frame dimensions). Assets include both static assets (e.g., a building design having a façade of various materials) and dynamic assets (e.g., target design component could be designed in the context of other component designs (relative, dependent assets). Assets can also include visual characteristics to create the environment. For example, in a design scenario for building aspects, the visual characteristics may involve simulation of lighting conditions. As another example, visual sensor simulations may be required to account for reaction to smoke or other visual inputs where visibility is a design objective. Assets contribute to the physics aspects as well. For example, a target design for a structure to be constructed on top of a platform requires knowledge of weight and material type to allow the algorithms to translate material properties on the actual object needed for stress simulations (e.g., thermal, tensile, shear, etc.). The details required for physics simulation are programmed in the background, not visible to the user interface as the user need not know all properties and characteristics for steel material, as an example.

Context conversion module 114 converts context assets to initial/boundary/loading conditions. This module is useful for translating user input, including high level input from non-expert users, to auto generate initial conditions, boundary conditions, loading conditions, and/or volume conditions to be set up, applied on the relevant boundaries or portions on the target entity or the assets even as the design changes, and constrained for the physics simulation. For example, in a scenario of simulating a heat-based process (e.g., 3D printing) to be performed in factory with a certain room temperature, the context conversion module is configured to translate the room temperature information to a volume temperature loading condition on the process simulation. The conversion involves both being able to detect that a certain simulation would be affected by a certain physics condition and computing the actual impact. For example, if the initial design for the heat-based process involves a radiator with certain specs as a context element instead of a defined room temperature, then the conversion would compute the expected temperature at the design object location in order to apply the proper condition.

Physics simulator module 115 executes physics simulations that augment environmental scenario assets by incorporating expected physics behavior, the effect of such behavior on other entities, and the impact of other physics aspects (e.g., generated by other entities) onto the target design entity. Physics simulation module 115 automatically extracts, from the context assets placed in the environmental scenario, all the physics fields currently active and the material and shape properties of the target design, the initial conditions, boundary conditions, loading conditions, and/or volume conditions that are necessary to virtually evaluate the current product design under the realistic dynamic conditions simulated in the platform 100. This module may include various solvers from which to select, including both fast numerical solvers that are reduced order based, and machine learning-based modeling solvers. The solver models are automatically selected by a framework controller 130 using a decision function that assesses the trade-off between speed and reliability of results. Faster results are possible by limiting the analysis to lower fidelity. Performance of the current product design is virtually evaluated to a desired accuracy, which may be defined by the user using the interactive platform module 112.

Design optimization module 116 is configured to utilize the results of near real time physics simulation to automatically suggest further design edits to the user (e.g., design edits related to topology optimization, shape optimization or generative design approaches). For example, by tracking the user's history of design attempts, design optimizer module 116 can extrapolate results toward the objective and identify design alternatives that move the design toward the objective. These design alternatives can then be suggested to the user for the next iterations.

In summary, the proposed framework includes: 1) fast solvers that are sufficient for preliminary design qualification; 2) an automatic translation of environmental context to conditions for the solver; and 3) a game-like interactive platform that delivers near real time simulation results to a user interface in response to design modifications and explorations.

Advantages of the disclosed embodiments over conventional approaches include the following. The proposed interactive framework concurrently predicts design and virtual performance and provides visualization of what-if scenarios in real-time. The proposed framework accounts for the real product environment and context. A seamless design process using a platform having virtual game-like response time easily sets up complex scenarios. Democratization of the simulation process via automated transfer of conditions and simulation inputs is based on the environmental context. Transfer of data between components is efficiently managed in the same system at the time of update. The proposed framework also allows use of existing scenario assets with their expected physics behavior, which enables designers and engineers with a varying level of domain expertise to collaborate and explore the design space effectively.

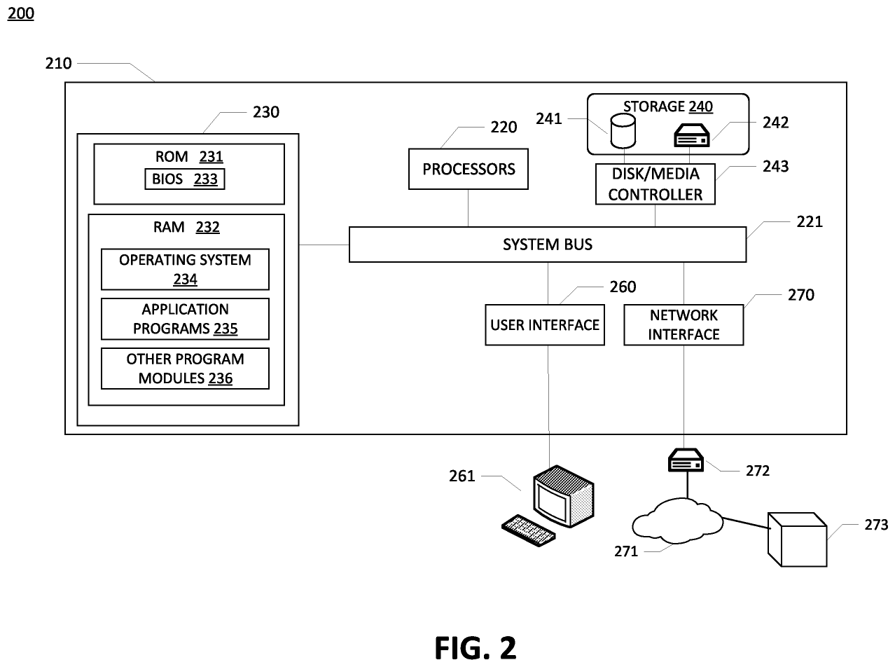

FIG. 2 illustrates an example of a computing environment within which embodiments of the present disclosure may be implemented. A computing environment 200 includes a computer system 210 that may include a communication mechanism such as a system bus 221 or other communication mechanism for communicating information within the computer system 210. The computer system 210 further includes one or more processors 220 coupled with the system bus 221 for processing the information. In an embodiment, computing environment 200 corresponds to a preliminary design validation system, in which the computer system 210 relates to a computer described below in greater detail.

The processors 220 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 220 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 221 may include at least one of a system bus, a memory bus, an address bus, or a message bus, and may permit exchange of information (e.g., data (including computer-executable code), signaling, etc.) between various components of the computer system 210. The system bus 221 may include, without limitation, a memory bus or a memory controller, a peripheral bus, an accelerated graphics port, and so forth. The system bus 221 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 2, the computer system 210 may also include a system memory 230 coupled to the system bus 221 for storing information and instructions to be executed by processors 220. The system memory 230 may include computer readable storage media in the form of volatile and/or nonvolatile memory, such as read only memory (ROM) 231 and/or random access memory (RAM) 232. The RAM 232 may include other dynamic storage device(s) (e.g., dynamic RAM, static RAM, and synchronous DRAM). The ROM 231 may include other static storage device(s) (e.g., programmable ROM, erasable PROM, and electrically erasable PROM). In addition, the system memory 230 may be used for storing temporary variables or other intermediate information during the execution of instructions by the processors 220. A basic input/output system 233 (BIOS) containing the basic routines that help to transfer information between elements within computer system 210, such as during start-up, may be stored in the ROM 231. RAM 232 may contain data and/or program modules that are immediately accessible to and/or presently being operated on by the processors 220. System memory 230 may additionally include, for example, operating system 234, application modules 235, and other program modules 236. Application modules 235 may include aforementioned modules described for FIG. 1 and may also include a user portal for development of the application program, allowing input parameters to be entered and modified as necessary.

The operating system 234 may be loaded into the memory 230 and may provide an interface between other application software executing on the computer system 210 and hardware resources of the computer system 210. More specifically, the operating system 234 may include a set of computer-executable instructions for managing hardware resources of the computer system 210 and for providing common services to other application programs (e.g., managing memory allocation among various application programs). In certain example embodiments, the operating system 234 may control execution of one or more of the program modules depicted as being stored in the data storage 240. The operating system 234 may include any operating system now known or which may be developed in the future including, but not limited to, any server operating system, any mainframe operating system, or any other proprietary or non-proprietary operating system.

The computer system 210 may also include a disk/media controller 243 coupled to the system bus 221 to control one or more storage devices for storing information and instructions, such as a magnetic hard disk 241 and/or a removable media drive 242 (e.g., floppy disk drive, compact disc drive, tape drive, flash drive, and/or solid state drive). Storage devices 240 may be added to the computer system 210 using an appropriate device interface (e.g., a small computer system interface (SCSI), integrated device electronics (IDE), Universal Serial Bus (USB), or FireWire). Storage devices 241, 242 may be external to the computer system 210.

The computer system 210 may include a user interface 260 for communication with a graphical user interface (GUI) 261, which may comprise one or more input/output devices, such as a keyboard, touchscreen, tablet and/or a pointing device, for interacting with a computer user and providing information to the processors 220, and a display screen or monitor. In an aspect, the GUI 261 relates to the user interface driven by interactive platform layer 112 in FIG. 1 as earlier described.

The computer system 210 may perform a portion or all of the processing steps of embodiments of the invention in response to the processors 220 executing one or more sequences of one or more instructions contained in a memory, such as the system memory 230. Such instructions may be read into the system memory 230 from another computer readable medium of storage 240, such as the magnetic hard disk 241 or the removable media drive 242. The magnetic hard disk 241 and/or removable media drive 242 may contain one or more data stores and data files used by embodiments of the present disclosure. The data store 240 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 220 may also be employed in a multi-processing arrangement to execute the one or more sequences of instructions contained in system memory 230. In alternative embodiments, hard-wired circuitry may be used in place of or in combination with software instructions. Thus, embodiments are not limited to any specific combination of hardware circuitry and software.

As stated above, the computer system 210 may include at least one computer readable medium or memory for holding instructions programmed according to embodiments of the invention and for containing data structures, tables, records, or other data described herein. The term “computer readable medium” as used herein refers to any medium that participates in providing instructions to the processors 220 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 241 or removable media drive 242. Non-limiting examples of volatile media include dynamic memory, such as system memory 230. Non-limiting examples of transmission media include coaxial cables, copper wire, and fiber optics, including the wires that make up the system bus 221. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to illustrations of methods, apparatus (systems), and computer program products according to embodiments of the disclosure. It will be understood that each block of the illustrations, and combinations of blocks in the illustrations, may be implemented by computer readable medium instructions.

The computing environment 200 may further include the computer system 210 operating in a networked environment using logical connections to one or more remote computers, such as remote computing device 273. The network interface 270 may enable communication, for example, with other remote devices 273 or systems and/or the storage devices 241, 242 via the network 271. Remote computing device 273 may be a personal computer (laptop or desktop), a mobile device, a server, a router, a network PC, a peer device or other common network node, and typically includes many or all of the elements described above relative to computer system 210. When used in a networking environment, computer system 210 may include modem 272 for establishing communications over a network 271, such as the Internet. Modem 272 may be connected to system bus 221 via user network interface 270, or via another appropriate mechanism.

Network 271 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 210 and other computers (e.g., remote computing device 273). The network 271 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 271.

It should be appreciated that the program modules, applications, computer-executable instructions, code, or the like depicted in FIG. 2 as being stored in the system memory 230 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 210, the remote device 273, and/or hosted on other computing device(s) accessible via one or more of the network(s) 271, may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

It should further be appreciated that the computer system 210 may include alternate and/or additional hardware, software, or firmware components beyond those described or depicted without departing from the scope of the disclosure. More particularly, it should be appreciated that software, firmware, or hardware components depicted as forming part of the computer system 210 are merely illustrative and that some components may not be present or additional components may be provided in various embodiments. While various illustrative program modules have been depicted and described as software modules stored in system memory 230, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The block diagrams in the Figures illustrate the architecture, functionality, and operation of possible implementations of systems, methods, and computer program products according to various embodiments of the present disclosure. In this regard, each block in the block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams illustration, and combinations of blocks in the block diagrams illustration, can be implemented by special purpose hardware-based systems that perform the specified functions or acts or carry out combinations of special purpose hardware and computer instructions.

What is claimed is:

1. A system for design exploration of a target design entity, comprising:
a memory having modules stored thereon; and
a processor for performing executable instructions in the modules stored on the memory, the modules comprising:
a realistic dynamic environment module configured to simulate dynamic conditions of an environment related to the target design entity;
an interactive platform module configured to drive a user interface for (1) interactive placement and modification of environmental scenario assets obtained from an asset library, (2) interactive placement of the target design entity within the virtual environment, and (3) intuitive modification of shape and material properties of the target design entity;
a context asset module configured to dynamically update assets for use by the realistic dynamic environment module;
a context conversion module configured to convert context assets to conditions; and
a physics simulator module configured to execute physics simulations that augment environmental scenario assets by incorporating expected physics behavior, the effect of such behavior on other entities, and the impact of other physics aspects generated by other entities onto the target design entity.

2. The system of claim 1, wherein the modules further comprise:
a design optimization module configured to suggest further design edits of the target design entity to the user based on results of the physics simulation.

3. The system of claim 2, wherein the design edits relate to topology optimization, shape optimization or generative design approaches.

4. The system of claim 1, wherein the physics simulator module comprises various solvers from which to select, including fast numerical solvers and machine learning-based modeling solvers.

5. The system of claim 1, wherein the solver models are automatically selected by a framework controller using a decision function that assesses a trade-off between speed and reliability of results.

6. The system of claim 1, wherein a game engine is used to implement the realistic dynamic environment module.

7. The system of claim 1, wherein the conditions include one or more of initial conditions, boundary conditions, loading conditions, and volume conditions.

8. A method for design exploration of a target design entity, comprising:
simulating dynamic conditions of an environment related to the target design entity;
driving a user interface for (1) interactive placement and modification of environmental scenario assets obtained from an asset library, (2) interactive placement of the target design entity within the virtual environment, and (3) intuitive modification of shape and material properties of the target design entity;
updating assets for use by the realistic dynamic environment module;
converting context assets to conditions; and
executing physics simulations that augment environmental scenario assets by incorporating expected physics behavior, the effect of such behavior on other entities, and the impact of other physics aspects generated by other entities onto the target design entity.

9. The method of claim 8, further comprising:
suggesting, by a design optimization module, further design edits of the target design entity to the user based on results of the physics simulation.

10. The method of claim 9, wherein the design edits relate to topology optimization, shape optimization or generative design approaches.

11. The method of claim 8, wherein the physics simulations comprise various solvers from which to select, including fast numerical solvers and machine learning-based modeling solvers.

12. The method of claim 8, wherein the solver models are automatically selected by a framework controller using a decision function that assesses a trade-off between speed and reliability of results.

13. The method of claim 8, wherein a game engine is used to implement the realistic dynamic environment module.

14. The method of claim 8, wherein the conditions include one or more of initial conditions, boundary conditions, loading conditions, and volume conditions.
